(19) United States
(12) Patent Application Publication
(10) Pub. No.: US 2022/0410129 A1
(43) Pub. Date: Dec. 29, 2022

(54) A CATALYST ARTICLE FOR CAPTURING PARTICULATE MATTER

(71) Applicant: BASF CORPORATION, Florham Park, NJ (US)

(72) Inventors: Pavel RUVINSKIY, Iselin, NJ (US); Manish SHARMA, Iselin, NJ (US); Glenn D. SVOBODA, Iselin, NJ (US); Matthew J. SCHLADT, Iselin, NJ (US); Yuxuan XIN, Plainsboro, NJ (US)

(21) Appl. No.: 17/756,194

(22) PCT Filed: Dec. 11, 2020
(86) PCT No.: PCT/US2020/064464

§ 371 Date: May 19, 2022

Related U.S. Application Data
(60) Provisional application No. 62/950,287, filed on Dec. 19, 2019.

(51) Int. Cl. B01J 23/46; B01J 21/04; B01J 23/10; B01J 37/00; B01J 37/02; B01J 37/08; B01J 35/00; B01J 35/02; B01J 35/10; B01D 53/94; F01N 3/28; F01N 3/10

(52) U.S. Cl. CPC B01J 23/464; B01J 21/04; B01J 23/10; B01J 37/0018; B01J 37/0219; B01J 37/088; B01J 35/0013; B01J 35/026; B01J 35/1066; B01J 35/1071; B01J 35/1076; B01J 35/0006; B01D 53/945; F01N 3/2803; F01N 3/101; B01D 2255/9155; B01D 2255/9022; B01D 2255/1023; B01D 2255/1025; B01D 2255/908; B01D 2255/9205; B01D 2255/9202; F01N 2370/02

(57) ABSTRACT

The present invention relates to a catalyst washcoat composition comprising a slurry comprising at least one platinum group metal and/or at least one non-platinum group metal supported on at least one support; and at least one pore forming agent having a particle size ranging from 100 nm to 5.0 μm, wherein the pore forming agent is selected from carbon nano-tubes, carbon nano-fibres, activated carbon, resins, cellulose powder, and polymer spheres. The present invention also provides a catalyst article for capturing particulate matter of size ranging from 1.0 nm to 100 μm, said article comprising the catalyst washcoat deposited on a substrate and calcined to form pores of which 50%-100% have a pore size ranging from 100 nm to 5.0 μm.

### CROSS-REFERENCE TO RELATED APPLICATIONS

This application claims the benefit of priority to U.S. Provisional Application No. 62/950,287, filed on Dec. 19, 2019 in its entirety.

### FIELD OF THE DISCLOSURE

The presently claimed invention relates to a catalyst article acting as a particulate filter for capturing particulate matter and is useful for treating exhaust stream to reduce pollutants.

### BACKGROUND

In general, diesel engine and gasoline engine exhaust gas contain hydrocarbons (HC), carbon monoxide (CO), nitrogen oxides (NOₓ) and particulate matter (PM). Catalyst article made of platinum group metal deposited on a substrate is typically provided in the gasoline/diesel engine exhaust system to convert certain or all of these exhaust components to innocuous components. Diesel exhaust system can contain one or more of a diesel oxidation catalyst, a soot filter and a catalyst for the reduction of NOₓ. Gasoline exhaust system can contain one of more of Three-Way Conversion (TWC) catalysts. The total particulate matter emissions of diesel exhaust are comprised of three main components. One component is the dry, solid carbonaceous fraction or soot. A second component of the particulate matter is the soluble organic fraction (“SOF”). The soluble organic fraction is sometimes referred to as the volatile organic fraction (“VOF”). The third component of the particulate matter is a sulfate fraction. With regard to gasoline exhaust, the PM is typically composed of two fractions: carbonaceous soot and ash (oxides, sulfates, etc.).

The particulate matter (PM) is categorized into various group based on their aerodynamic diameter such as (i) PM-10—particles of an aerodynamic diameter of less than 10 μm; (ii) fine particles of diameter below 2.5 μm (PM-2.5); (iii) ultrafine particles of diameter below 0.1 μm (or 100 nm); and (iv) nanoparticles, characterized by diameters of less than 50 nm. Particulate, generated by the gasoline engine is typically smaller in size (size distribution is centered at around 25 nm) and up to two orders of magnitude lower in quantity, compared to diesel PM. Fine and ultrafine particulate are considered as strong public health hazard. Whereas, diesel PM had been routinely regulated at national and international level, gasoline PM have been only recently recognized as a public health hazard. Specifically, CARB 2025 is expected to place a 1 mg mi⁻¹ cap on light-duty gasoline PM emissions; Euro 6 regulation currently requires the direct-injection vehicles to meet 0.005 g km⁻¹ and 6.0×10¹¹ mass-based and number-based respective limits on the emissions from the direct-injection vehicles. Given the late start of the development of the gasoline PM abatement field, compared to a diesel counterpart, a concentrated effort of the scientific community is required in order to minimize the transition time between the fundamental research and industrial scale production.

With respect to the diesel applications, one key after-treatment technology in use for the PM reduction is the diesel particulate filter. Particulate collection of diesel particulates in a diesel particulate filter is based on the principle of separating gas-borne particulates from the gas phase using a porous barrier. Diesel filters can be deep-bed filters and/or surface-type filters. In deep-bed filters, the mean pore size of filter media is bigger than the mean diameter of collected particles. The particles are deposited on the media through a combination of depth filtration mechanisms, including diffusional deposition (Brownian motion), inertial deposition (impaction) and flow-line interception (Brownian motion or inertia). In surface-type filters, the pore diameter of the filter media is less than the diameter of the PM, so PM is separated by sieving. Separation is done by a build-up of collected diesel PM itself, which build-up is commonly referred to as “filtration cake” and the process as “cake filtration”.

There are many known filter structures used for removing PM from diesel exhaust, such as honeycomb wall flow filters, wound or packed fiber filters, open cell foams, sintered metal filters, etc. However, ceramic wall flow filters, receive the most attention. The filter is a physical structure for removing particles from exhaust, and the accumulating particles will increase the back pressure from the filter on the engine. Thus, the accumulating particles must be continuously or periodically burned out of the filter to maintain an acceptable back pressure.

Further, in the case of the catalyst article coated with PGM and used as a filter, one may experience a reduction in the gas diffusion properties of the exhaust gas when the exhaust gas flows into the catalyst component, thereby reducing the capacity of the filter.

Although some learnings from the diesel PM abatement research can be transferred to gasoline applications, the unique size and chemical characteristics of the gasoline PM pose new and hitherto unencountered challenges. As such the transfer of a diesel PM filter to the gasoline system will be ineffective. The efficient Gasoline Particulate Filter (GPF) or Four Way Catalyst (FWC) must possess a set of unique characteristics optimized to the gasoline exhaust properties. In particular, the analysis of the porosity/pore size distribution of coated GPF/FWC catalysts reveals that pores can be classified into two major groups, up to meso-pores (2 nm to 50 nm) and higher end of the macropore spectrum (≈10 μm). At the same time, FWC filtration efficiency demonstrates that PM of size, between ≈100 nm and 5 μm, are not captured efficiently. This has great effect on particulate mass and particulate number filtration efficiency of the FWC.

The present invention envisages to solve this issue via utilization of advanced pore-formers that can be introduced into catalyst slurry.

### SUMMARY OF THE DISCLOSURE

The presently claimed invention provides a catalyst washcoat composition comprising a slurry comprising at least one platinum group metal and/or at least one non-platinum group metal supported on at least one support; and at least one pore forming agent having a particle size ranging from 100 nm to 5.0 μm, wherein the pore forming agent is selected from carbon nano-tubes, carbon nano-fibres, activated carbon, resins, cellulose powder, and polymer spheres.

The presently claimed invention also provides a catalyst article for capturing particulate matter, said article comprising a calcined porous washcoat deposited on a substrate, wherein the calcined porous washcoat comprising at least one platinum group metal and/or at least one non-platinum group metal supported on at least one support, wherein the calcined porous washcoat comprises pores of which 50% to100% have a pore size ranging from 100 nm to 5.0 μm, wherein the size of the particulate matter ranges from 1.0 nm to 100 μm. In one embodiment, the presently claimed invention provides a catalyst article for capturing particulate matter, said article comprising a calcined porous washcoat deposited on a substrate, wherein calcined porous washcoat comprises at least one platinum group metal and/or at least one non-platinum group metal supported on at least one support, wherein the porous washcoat comprises pores of which 50%to 100% have a pore size ranging from 100 nm to 5.0 μm, wherein the pores are formed during calcination and/or post-calcination of the washcoat slurry deposited on the substrate, wherein the washcoat slurry comprises the at least one platinum group metal and/or the at least one non-platinum group metal supported on the at least one support, and a pore forming agent having a particle size ranging from 100 nm to 5.0 μm, said pore forming agent is selected from carbon nano-tubes, carbon nano-fibres, activated carbon, resins, cellulose powder, and polymer spheres, wherein the size of particulate matter ranges from 1.0 nm to 100 μm. The presently claimed invention also provides a process for preparing the catalyst article according to the presently claimed invention, wherein the process comprises i) preparing a catalyst washcoat composition comprising slurry comprising at least one platinum group metal and/or at least one non-platinum group metal supported on at least one support; and at least one pore forming agent selected from carbon nano-tubes, carbon nano-fibres, activated carbon, resins, cellulose powder, and polymer spheres; ii) depositing the washcoat composition on a substrate; and iii) calcining at a temperature in the range of 500 to 600° C. to obtain the catalyst article with porous washcoat, wherein the porous washcoat comprises pores of which 50%to 100% have a pore size ranging from 100 nm to 5.0 μm.

### BRIEF DESCRIPTION OF THE ACCOMPANYING DRAWINGS

In order to provide an understanding of embodiments of the invention, reference is made to the appended drawings, which are not necessarily drawn to scale, and in which reference numerals refer to components of exemplary embodiments of the invention. The drawings are exemplary only and should not be construed as limiting the invention. The above and other features of the presently claimed invention, their nature, and various advantages will become more apparent upon consideration of the following detailed description, taken in conjunction with the accompanying drawings:

FIGS. 1A to 1F illustrate PM emissions in terms of PN (Particle Number) for selected particulate size; panels (a) through (c) were measured for cycle RTS-95, panels (d) through (f) for cycle WLTP.

FIG. 2 illustrates Hg porosimetry data measured for a typical four-way catalyst (FWC) system.

### DETAILED DESCRIPTION

The presently claimed invention now will be described more fully hereafter. The presently claimed invention may be embodied in many different forms and should not be construed as limited to the embodiments set forth herein; rather, these embodiments are provided so that this presently claimed invention will be thorough and complete, and will fully convey the scope of the invention to those skilled in the art. No language in the specification should be construed as indicating any non-claimed element as essential to the practice of the disclosed materials and methods.

The use of the terms “a”, “an”, “the”, and similar referents in the context of describing the materials and methods discussed herein (especially in the context of the following claims) are to be construed to cover both the singular and the plural, unless otherwise indicated herein or clearly contradicted by context.

The term “about” used throughout this specification is used to describe and account for small fluctuations. For example, the term “about” refers to less than or equal to ±5%, such as less than or equal to ±2%, less than or equal to ±1%, less than or equal to ±0.5%, less than or equal to ±0.2%, less than or equal to ±0.1% or less than or equal to ±0.05%. All numeric values herein are modified by the term “about,” whether or not explicitly indicated. A value modified by the term “about” of course includes the specific value. For instance, “about 5.0” must include 5.0.

All methods described herein can be performed in any suitable order unless otherwise indicated herein or otherwise clearly contradicted by context. The use of any and all examples, or exemplary language (e.g., “such as”) provided herein, is intended merely to better illustrate the materials and methods and does not pose a limitation on the scope unless otherwise claimed.

In first aspect, the presently claimed invention provides a catalyst washcoat composition comprising a slurry comprising at least one platinum group metal and/or at least one non-platinum group metal supported on at least one support; and at least one pore forming agent having a particle size ranging from 100 nm to 5.0 μm, wherein the pore forming agent is selected from carbon nano-tubes, carbon nano-fibres, activated carbon, resins, cellulose powder, and polymer spheres. The catalyst washcoat composition comprising a slurry is utilized to prepare a catalyst article having a porous washcoat. In one exemplary embodiment, the slurry comprises at least one platinum group metal supported on at least one support. In another exemplary embodiment, the slurry comprises at least one non-platinum group metal supported on at least one support. In still another exemplary embodiment, the slurry comprises a combination of at least one platinum group metal and at least one non-platinum group metal supported on at least one support.

Thus, the presently claimed invention also provides a catalyst article for capturing particulate matter of a pre-determined size such as size ranging from 1.0 nm to 100 μm. The catalyst article comprises a calcined porous washcoat deposited on a substrate, wherein washcoat comprising at least one platinum group metal and/or at least one non-platinum group metal supported on at least one support, wherein the calcined porous washcoat comprises pores of which 50%-100% have a pore size ranging from 100 nm to 5 μm. The Brunauer, Emmett, and Teller (BET) technique and Hg-porosimetry method are used to measure the pore size. In one embodiment, the presently claimed invention provides a catalyst article for capturing particulate matter, said article comprising a calcined porous washcoat deposited on a substrate, wherein the calcined porous washcoat comprising at least one platinum group metal and/or at least one non-platinum group metal supported on at least one support, wherein the calcined porous washcoat comprises pores of which 50%to 100% have a pore size ranging from 100 nm to 5.0 μm, wherein the pores are formed during calcination and/or post-calcination of the washcoat slurry deposited on the substrate, wherein the washcoat slurry comprises the at least one platinum group metal and/or the at least one non-platinum group metal supported on the at least one support, and a pore forming agent having a particle size ranging from 100 nm to 5.0 μm, said pore forming agent is selected from carbon nano-tubes, carbon nano-fibres, activated carbon, resins, cellulose powder, and polymer spheres, wherein the size of the particulate matter ranges from 1.0 nm to 100 μm. In one embodiment, the presently claimed invention provides a catalyst article for capturing particulate matter, said article comprising a calcined porous washcoat deposited on a substrate, wherein the calcined porous washcoat comprising at least one platinum group metal supported on at least one support, wherein the calcined porous washcoat comprises pores of which 50% to 100% have a pore size ranging from 100 nm to 5.0 μm, wherein the pores are formed during calcination and/or post-calcination of the washcoat slurry deposited on the substrate, wherein the washcoat slurry comprises the at least one platinum group metal supported on the at least one support, and a pore forming agent having a particle size ranging from 100 nm to 5.0 μm, said pore forming agent is selected from carbon nano-tubes, carbon nano-fibres, activated carbon, resins, cellulose powder, and polymer spheres, wherein the size of the particulate matter ranges from 1.0 nm to 100 μm. In one embodiment, the presently claimed invention provides a catalyst article for capturing particulate matter, said article comprising a calcined porous washcoat deposited on a substrate, wherein the calcined porous washcoat comprising at least one non-platinum group metal supported on at least one support, wherein the calcined porous washcoat comprises pores of which 50%to 100% have a pore size ranging from 100 nm to 5.0 μm, wherein the pores are formed during calcination and/or post-calcination of the washcoat slurry deposited on the substrate, wherein the washcoat slurry comprises at least one non-platinum group metal supported on the at least one support, and a pore forming agent having a particle size ranging from 100 nm to 5.0 μm, said pore forming agent is selected from carbon nano-tubes, carbon nano-fibres, activated carbon, resins, cellulose powder, and polymer spheres, wherein the size of the particulate matter ranges from 1.0 nm to 100 μm. In one embodiment, the presently claimed invention provides a catalyst article for capturing particulate matter, said article comprising a calcined porous washcoat deposited on a substrate, wherein the calcined porous washcoat comprising at least one platinum group metal and at least one non-platinum group metal supported on at least one support, wherein the calcined porous washcoat comprises pores of which 50%to 100% have a pore size ranging from 100 nm to 5.0 μm, wherein the pores are formed during calcination and/or post-calcination of the washcoat slurry deposited on the substrate, wherein the washcoat slurry comprises the at least one platinum group metal and the at least one non-platinum group metal supported on the at least one support, and a pore forming agent having a particle size ranging from 100 nm to 5.0 μm, said pore forming agent is selected from carbon nano-tubes, carbon nano-fibres, activated carbon, resins, cellulose powder, and polymer spheres, wherein the size of the particulate matter ranges from 1.0 nm to 100 μm. In one embodiment, the calcined porous washcoat comprises pores of which 50%to 100% have a pore size ranging from 100 nm to 2.5 μm. In one embodiment, the pore forming agent have a particle size ranging from 100 nm to 2.5 μm. The pore size of the calcined washcoat (post-calcination) corresponds to the particle size of the pore-forming agent present in the washcoat slurry. i.e. the pores generated after calcination will have a pore size which is equivalent to the particle size of the pore forming agent used in making the washcoat. In one embodiment, the pores of the calcined washcoat are able to capture the particulate matter having a size in the range of 5.0 nm to 50 μm.

The substrate utilized for depositing the washcoat composition is ceramic or metal. Typically, the substrate is a flow-through monolithic substrate or a wall flow substrate. The platinum group metal or a non-platinum group metal is impregnated on the support material.

The platinum group metal utilized according to the present invention is selected from platinum, palladium, rhodium and a combination thereof, whereas the non-platinum group metal is selected from nickel, copper, zinc, manganese, neodymia, lanthana praseodymium, and a combination thereof. The exemplary support includes an alumina component, an oxygen storage component, a zirconia component, a ceria component and a combination thereof.

In one embodiment, the porous washcoat is a bi-layered washcoat comprising a first layer and a second layer, wherein the first layer comprises i) palladium or rhodium supported on an oxygen storage component; and ii) optionally, platinum supported on an alumina component, wherein the second layer comprises i) rhodium supported on one of an oxygen storage component and an alumina component, or ii) palladium supported on one of an alumina component and an oxygen storage component, or iii) rhodium and platinum supported on an oxygen storage component, or iv) palladium supported on an oxygen storage component and platinum supported on an alumina component, or v) palladium and platinum supported on an alumina component.

In another aspect of the presently claimed invention, there is provided a process for preparing the catalyst article described herein above, the process comprises i) preparing a catalyst washcoat composition comprising slurry comprising at least one platinum group metal and/or at least one non-platinum group metal supported on at least one support; and at least one pore forming agent selected from carbon nano-tubes, carbon nano-fibres, activated carbon, resins, cellulose powder, and polymer spheres; ii) depositing the washcoat composition on a substrate; and iii) calcining at a temperature in the range of 500 to 600° C. to obtain the catalyst article with porous washcoat, wherein the porous washcoat comprises pores of which 50%to 100% have a pore size ranging from 100 nm to 5.0 μm.

In another aspect of the presently claimed invention, there is provided an exhaust system for internal combustion engines, said system comprises the catalyst article according to the presently claimed invention. In one embodiment, the system further comprises an additional platinum group metal based three-way conversion catalyst article which is positioned downstream from an internal combustion engine, and wherein the catalyst article comprising calcined porous washcoat is positioned downstream in fluid communication with the platinum group metal based three-way conversion catalyst article. Typically, the three-way conversion (TWC) catalyst is convention catalyst and is provided at CC1 (close-coupled) position whereas the catalyst article comprising calcined porous washcoat is provided at CC2 position. In another embodiment, the system further comprises an additional platinum group metal based three-way conversion catalyst article, wherein the catalyst article comprising calcined porous washcoat is positioned downstream from an internal combustion engine and the platinum group metal based three-way conversion catalyst article is positioned downstream in fluid communication with the catalyst article comprising calcined porous washcoat .

In another aspect of the presently claimed invention, there is provided a method of treating a gaseous exhaust stream comprising hydrocarbons, carbon monoxide, nitrogen oxides, and particulate matter, the method comprising contacting the exhaust stream with the catalyst article or the exhaust system according to the presently claimed invention.

In another aspect of the presently claimed invention, there is provided a method of reducing hydrocarbons, carbon monoxide, nitrogen oxides, and particulate matter levels in a gaseous exhaust stream, the method comprising contacting the gaseous exhaust stream with the catalyst article or the exhaust system according to the presently claimed invention to reduce the levels of hydrocarbons, carbon monoxide, nitrogen oxides, and particulate matter in the exhaust gas.

In another aspect of the presently claimed invention, there is provided use of the catalyst article or the exhaust system according to the presently claimed invention for purifying a gaseous exhaust stream comprising hydrocarbons, carbon monoxide, nitrogen oxides, and particulate matter.

### EXAMPLES

Aspects of the presently claimed invention are more fully illustrated by the following examples, which are set forth to illustrate certain aspects of the present invention and are not to be construed as limiting thereof.

### Example 1

A catalyst composite/article was prepared containing a single-layer catalyst having palladium (Pd) and rhodium (Rh) metals in the same layer. A wash-coat was prepared by separately impregnating Pd onto an oxygen storage component (OSC) and Rh onto a stabilized alumina. The first impregnated support was prepared by incipient wetness impregnation of a palladium nitrate solution, diluted to minimize the metal concentration, onto 1.02 g/in³ of an oxygen storage component (OSC, CeO₂—ZrO₂—La₂O₃—Nd₂O₃—Y₂O₃, 40% CeO₂) resulting in 2.0 g/ft³ Pd. The second impregnated support was prepared by adding a Rh nitrate solution, diluted to minimize the metal concentration, onto 0.37 g/in³ of a refractory alumina oxide resulting in 3.5 g/ft³ Rh. A single aqueous washcoat was formed by dispersing the impregnated supports in water and acid, e.g. nitric acid or acetic acid. Also, promoters of Ba, Zr, and octanol were dispersed therein. The obtained slurry was milled and coated onto a filter/substrate monolith at a loading of 1.48 g/in³ followed by drying at 110° C. in air and calcination at 550° C. in air.

### Example 2

Various single aqueous washcoats containing palladium (Pd) and rhodium (Rh) metals were prepared as per the process provided in example 1. Additionally, at least one pore forming agent having a particle size ranging from 100 nm to 5.0 μm selected from carbon nano-tubes, carbon nano-fibres, activated carbon, resins, cellulose powder, and polymer spheres was added to the washcoat followed by mixing. Each obtained slurry was milled and coated onto a separate filter/substrate monolith followed by drying at 110° C. in air and calcination at 550° C. in air. The calcined porous washcoat comprises pores of which 50% to 100% have a pore size ranging from 100 nm to 5.0 μm. The pore size of the calcined washcoat is found to be equal to the particle size of the pore-forming agent present in the washcoat slurry.

The measurements were conducted using a test engine-bench with 2.0 L TGDI Engine. The analytical equipment used several points of measurements, e.g. at the “engine-out”, at the “tail-pipe”, etc. and included a suite of instruments, including H-FID (H₂-Flame Ionization Detector), NDIR (Nondispersive Infra-Red detector), and Particle Analyzer. The measurements were conducted according to two standard driving cycles, RTS-95 and WLTP.

The filtration efficiency of the whole filter (substrate) is determined by considering three physical mechanisms of filtration process:
i) Diffusion: a particle hits a collector due to Brownian motion;
ii) Interception: a particle hits a collector by following a gas stream close to the collector;
iii) Impaction: a particle hits the collector because its inertia cannot follow the gas stream.
   The variables such as substrate properties, flow conditions and particle size and pore size distribution are considered while determining the filtration efficiency.

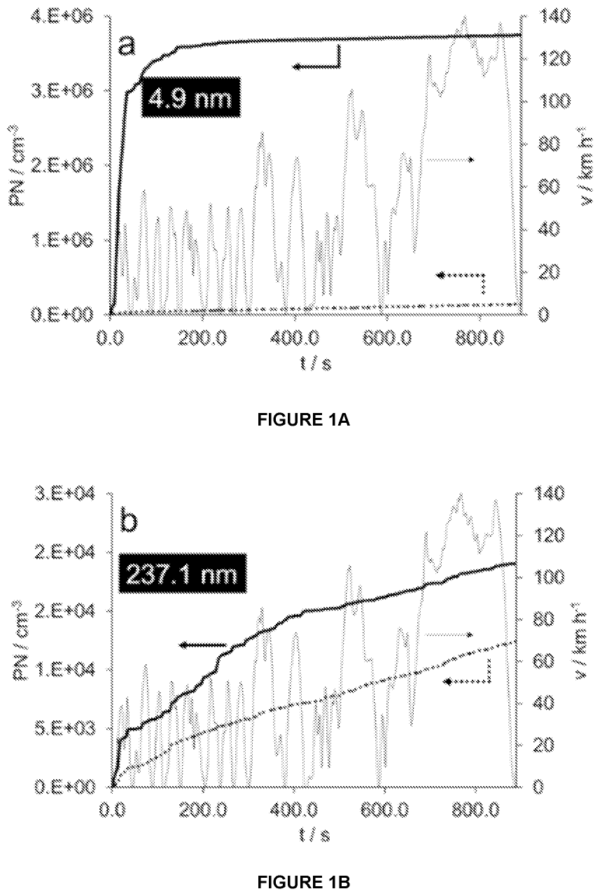

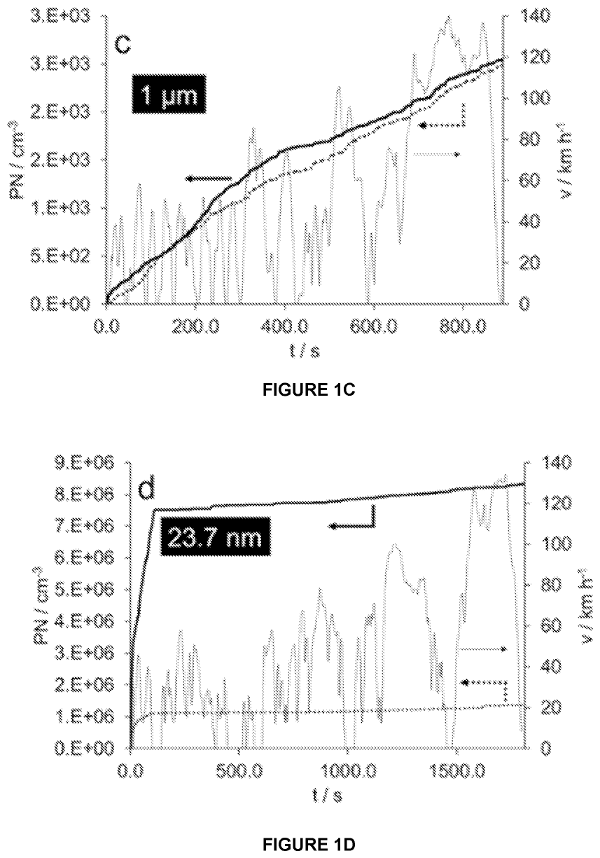

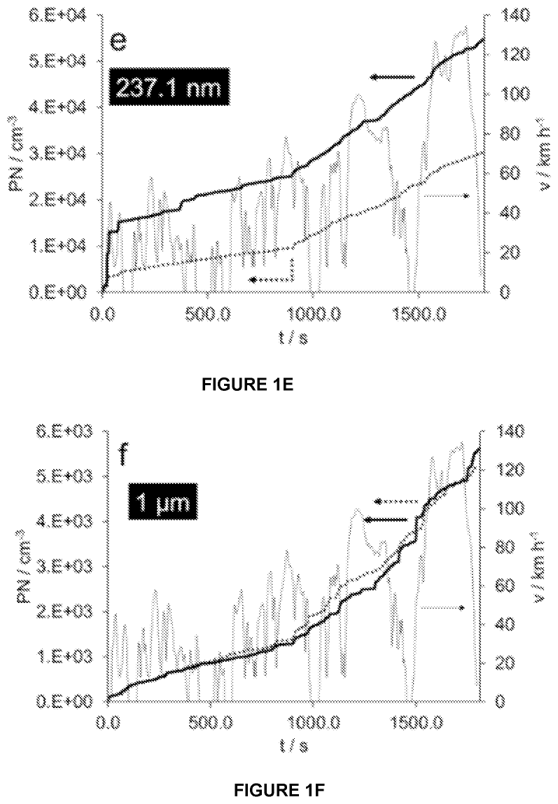

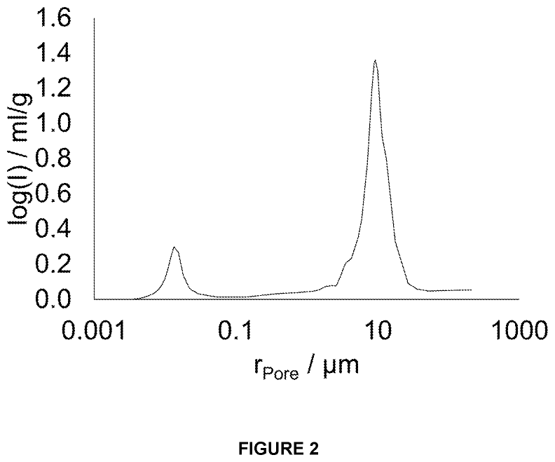

FIG. 1 shows PM emissions in terms of PN (Particle Number) measurement for selected particulate size. Panels (a) through (c) were measured for cycle RTS-95 and panels (d) through (f) was measured for cycle WLTP. As can be seen, transition of particle size from <30 nm (high filtration efficiency) to up to 1 μm (low filtration efficiency) leads to a dramatic change in efficiency of filtration. On the other hand, FIG. 2 shows Hg porosimetry data measured for a typical four-way catalyst (FWC) system. As can be seen, there are two distinct pore size peaks (at around 10 nm and around 10 μm), while the target capture is 23 nm to 2.5 μm. Thus, there is requirement of pores in the intermediate size range to improve the particulate capture/filtration efficiency. The sensitivity of different substrate properties is summarized in Table 1.

TABLE 1
Filtration efficiency as a function of several primary
parameters characterizing the catalyst article.

| | | Filtration | | |
|---|---|---|---|---|
| Substrate | | Efficiency | Sensitivity | |
| Property | Range | (%) | Dimensional | Dimensionless |
| Diameter/in | 2.3-9.3 | 52-73 | 3.5 | 16.4 |
| Length/in | 3-12 | 57-67 | 1.4 | 8.4 |
| Cell Density | 150-600 | 60-64 | 0.01 | 3.6 |
| WT*/mm | 4-16 | 50-72 | 2.4 | 18.9 |
| Porosity/% | 29-100 | 56-66 | −13.6 | −7.9 |
| Mean Pore Size/ | 8-32 | 43-81 | −1.9 | −30.6 |
| μm | | | | |
| Standard | 0.9-3.6 | 9-98 | −41 | −74 |
| Deviation/μm | | | | |

*WT—Washcoat Thickness

As can be seen, pore structure in terms of mean pore size and standard deviation of pore size distribution shows a significantly higher impact compared to other substrate properties. As a result, it can be confirmed that, by fine-tuning the porosity of the catalyst article as described in this invention, it can effectively capture the particulate contained in the exhaust gas, that would otherwise escape into the environment.

Reference throughout this specification to “one embodiment,” “certain embodiments,” “one or more embodiments” or “an embodiment” means that a particular feature, structure, material, or characteristic described in connection with the embodiment is included in at least one embodiment of the presently claimed invention. Thus, the appearances of the phrases such as “in one or more embodiments,” “in certain embodiments,” “in some embodiments,” “in one embodiment,” or “in an embodiment” in various places throughout this specification are not necessarily referring to the same embodiment of the presently claimed invention. Furthermore, the particular features, structures, materials, or characteristics may be combined in any suitable manner in one or more embodiments. All of the various embodiments, aspects, and options disclosed herein can be combined in all variations, regardless of whether such features or elements are expressly combined in a specific embodiment description herein. This presently claimed invention is intended to be read holistically such that any separable features or elements of the disclosed invention, in any of its various aspects and embodiments, should be viewed as intended to be combinable unless the context clearly dictates otherwise.

Although the embodiments disclosed herein have been described with reference to particular embodiments it is to be understood that these embodiments are merely illustrative of the principles and applications of the presently claimed invention. It will be apparent to those skilled in the art that various modifications and variations can be made to the methods and apparatus of the presently claimed invention without departing from the spirit and scope of the presently claimed invention. Thus, it is intended that the presently claimed invention include modifications and variations that are within the scope of the appended claims and their equivalents, and the above-described embodiments are presented for purposes of illustration and not of limitation. All patents and publications cited herein are incorporated by reference herein for the specific teachings thereof as noted, unless other statements of incorporation are specifically provided.

1. A catalyst washcoat composition comprising a slurry comprising at least one platinum group metal and/or at least one non-platinum group metal supported on at least one support; and at least one pore forming agent having a particle size ranging from 100 nm to 5.0 μm, wherein the pore forming agent is selected from carbon nano-tubes, carbon nano-fibres, activated carbon, resins, cellulose powder, and polymer spheres.

2. A catalyst article for capturing particulate matter, said article comprising a calcined porous washcoat deposited on a substrate, wherein the calcined porous washcoat comprises at least one platinum group metal and/or at least one non-platinum group metal supported on at least one support, wherein the calcined porous washcoat comprises pores of which 50% to 100% have a pore size ranging from 100 nm to 5.0 μm, wherein the size of the particulate matter ranges from 1.0 nm to 100 μm.

3. A catalyst article for capturing particulate matter, said article comprising a calcined porous washcoat deposited on a substrate, wherein the calcined porous washcoat comprises at least one platinum group metal and/or at least one non-platinum group metal supported on at least one support, wherein the calcined porous washcoat comprises pores of which 50% to 100% have a pore size ranging from 100 nm to 5.0 μm, wherein the pores are formed during calcination and/or post-calcination of a washcoat slurry deposited on the substrate, wherein the washcoat slurry comprises the at least one platinum group metal and/or the at least one non-platinum group metal supported on the at least one support, and at least one pore forming agent having a particle size ranging from 100 nm to 5.0 μm, said pore forming agent is selected from carbon nano-tubes, carbon nano-fibres, activated carbon, resins, cellulose powder, and polymer spheres, wherein the size of the particulate matter ranges from 1.0 nm to 100 μm.

4. The catalyst article according to claim 3, wherein the porous washcoat comprises pores of which 50% to 100% have a pore size ranging from 100 nm to 2.5 μm.

5. The catalyst article according to claim 3, wherein the pore forming agent have a particle size ranging from 100 nm to 2.5 μm.

6. The catalyst article according to claim 3, wherein the pore size of the calcined washcoat equals to the particle size of the pore-forming agent present in the washcoat slurry.

7. The catalyst article according to claim 3, wherein the substrate is ceramic or metallic.

8. The catalyst article according to claim 3, wherein the substrate is a flow-through monolithic substrate or a wall flow substrate.

9. The catalyst article according to claim 3, wherein the platinum group metal or the non-platinum group metal is impregnated on the support.

10. The catalyst article according to claim 3, wherein the platinum group metal is selected from platinum, palladium, rhodium and a combination thereof.

11. The catalyst article according to claim 3, wherein the non-platinum group metal is selected from nickel, copper, zinc, manganese, neodymium, lanthanum, praseodymium and a combination thereof.

12. The catalyst article according to claim 3, wherein the particle size of the particulate matter is in the range of 5.0 nm to 50 μm.

13. The catalyst article according to claim 3, wherein the support is selected from an alumina component, an oxygen storage component, a zirconia component, a ceria component, and a combination thereof.

14. The catalyst article according to claim 3, wherein the porous washcoat is a bi-layered washcoat comprising a first layer and a second layer,
wherein the first layer comprises i) palladium or rhodium supported on an oxygen storage component; and ii) optionally, platinum supported on an alumina component, and
wherein the second layer comprises i) rhodium supported on one of an oxygen storage component and an alumina component, or ii) palladium supported on one of an alumina component and an oxygen storage component, or iii) rhodium and platinum supported on an oxygen storage component, or iv) palladium supported on an oxygen storage component and platinum supported on an alumina component, or v) palladium and platinum supported on an alumina component.

15. A process for preparing the catalyst article according claim 3, wherein the process comprises i) preparing a catalyst washcoat composition comprising slurry comprising at least one platinum group metal and/or at least one non-platinum group metal supported on at least one support; and at least one pore forming agent selected from carbon nano-tubes, carbon nano-fibres, activated carbon, resins, cellulose powder, and polymer spheres; ii) depositing the washcoat composition on a substrate; and iii) calcining at a temperature in the range of 500 to 600° C. to obtain the catalyst article with porous washcoat, wherein the porous washcoat comprises pores of which 50% to 100% have a pore size ranging from 100 nm to 5 μm.

16. An exhaust system for internal combustion engines, said system comprises the catalyst article according to claim 3.

17. The exhaust system according to claim 16, wherein said system further comprises an additional platinum group metal based three-way conversion catalyst article which is positioned downstream from an internal combustion engine, whereas the catalyst article comprising calcined porous washcoat according to claim 3 is positioned downstream in fluid communication with the platinum group metal based three-way conversion catalyst article.

18. The exhaust system according to claim 16, wherein said system further comprises an additional platinum group metal based three-way conversion catalyst article, wherein the catalyst article comprising calcined porous washcoat according to any of claims 2 to 14 is positioned downstream from an internal combustion engine and the platinum group metal based three-way conversion catalyst article is positioned downstream in fluid communication with the catalyst article comprising calcined porous washcoat according to any of claims 2 to 14.

19. A method of treating a gaseous exhaust stream comprising hydrocarbons, carbon monoxide, nitrogen oxides, and particulate matter, the method comprising contacting the exhaust stream with the catalyst article according to claim 3.

20. A method of reducing hydrocarbons, carbon monoxide, nitrogen oxides, and particulate matter levels in a gaseous exhaust stream, the method comprising contacting the gaseous exhaust stream with the catalyst article according to claim 3 to reduce the levels of hydrocarbons, carbon monoxide, nitrogen oxides, and particulate matter in the exhaust gas.

21. (canceled)
